(19) United States
(12) Patent Application Publication
(10) Pub. No.: US 2014/0196131 A1
(43) Pub. Date: Jul. 10, 2014

(54) USER AUTHENTICATION BASED ON A WRIST VEIN PATTERN

(71) Applicant: SALUTRON, INC., Fremont, CA (US)

(72) Inventor: Yong Jin Lee, Palo Alto, CA (US)

(21) Appl. No.: 13/844,344

(22) Filed: Mar. 15, 2013

Related U.S. Application Data
(60) Provisional application No. 61/749,519, filed on Jan. 7, 2013.

(51) Int. Cl. G06F 21/35; G06F 21/32

(52) U.S. Cl. CPC G06F 21/35; G06F 21/32
USPC 726/7; 726/5

(57) ABSTRACT

Technology is described for authenticating a user based on a wrist vein pattern. A wrist contact sensor device detects a wrist vein pattern. The wrist contact sensor device may be wearable by being positioned by a wearable support structure like a wristband. One or more pattern recognition techniques may be used to identify whether a match exists between a wrist vein pattern being detected by the sensors and data representing a stored wrist vein pattern. A user may be authenticated based on whether a match is identified satisfying matching criteria.

### CROSS-REFERENCE TO RELATED APPLICATION

This application claims priority under 35 USC §119(e) to U.S. provisional patent application No. 61/749,519 to inventor Yong Jin Lee filed on Jan. 7, 2013 entitled “User Authentication Based on a Wrist Vein Pattern” which is hereby incorporated by reference.

### BACKGROUND

Authentication of a user's identity involves verifying a user is who he or she represents himself or herself to be or that the user has proper credentials, typically for accessing data or a service. Authentication is particularly useful in computer security to prevent a user from accessing data available via a computer system but for which the user does not have access permission. Biometric authentication techniques may be used; however, authentication may be desired on a continuous basis and in a manner which does not interrupt the user's activity in interfacing with an application, computer system or machine controlled by a computer system. For example, distraction caused by interrupting a user to re-enter a password or put his or her eye to a retinal scanning device while engaged in an activity is to be avoided.

### SUMMARY

The technology provides for systems and methods for authenticating a user based on wrist vein pattern data. Additionally, the technology provides one or more embodiments of a wrist contact sensor device for capturing user wrist vein pattern data. An embodiment of a wrist contact sensor device comprises a plurality of sensors positioned in the device for contacting skin of a user on a palmar side of the wrist. The sensors detect reflections and generate detection signals based on the detected reflections. The sensor device also comprises at least one illuminator positioned in the device for directing illumination at the skin of the user on the palmar side of the wrist. Sensor interface circuitry generates digital data representing a wrist vein pattern for the user based on the detection signals. The sensor interface circuitry sends the digital data representing the wrist vein pattern to one or more communicatively coupled processors.

In some embodiments, the one or more processors are communicatively coupled to one or more computer systems having accessing to stored data representing one or more reference wrist vein patterns and the one or more processors send the digital data representing the wrist vein pattern to the computer system. The one or more computers system performs one or more pattern recognition techniques comparing the detected wrist vein pattern with stored data representing the one or more reference wrist vein patterns for identifying a matching wrist vein pattern within a matching criteria

In another embodiment, a wrist contact sensing system includes one or more processors, a wrist contact sensor device and a memory which may store one or more reference wrist vein patterns. The one or more processors perform one or more pattern recognition techniques for identifying a matching wrist vein pattern within a matching criteria based on the one or more reference patterns. Responsive to finding a match, the user is authenticated as a user associated with the matching stored wrist vein pattern. In other embodiments, the wrist contact sensing system in combination with other computer systems may perform one or more authentication methods.

The technology provides one or more embodiments of a method for authenticating a user based on data representing a wrist vein pattern. An embodiment of the method comprises receiving digital data representing a wrist vein pattern from a wrist contact sensing system and automatically comparing the digital data representing the wrist vein pattern using one or more pattern recognition techniques for identifying a matching reference wrist vein pattern satisfying a matching criteria. Responsive to finding a matching reference wrist vein pattern, automatically assigning an identity stored for the matching reference wrist vein pattern to a user associated with the received digital data representing the wrist vein pattern. One or more executing applications requesting user authentication are notified of the assigned identity of the user.

Another embodiment of a method for authenticating a user based on data representing a wrist vein pattern comprises generating digital data representing a wrist vein pattern based on detection signals representing infrared reflections detected by one or more infrared (IR) sensitive sensors in contact with skin on a palmar side wrist and automatically authenticating a user identity associated with the generated digital data using one or more pattern recognition techniques based on one or more reference wrist vein patterns. One or more executing applications requesting user authentication are notified whether the user identity was authenticated or not.

The technology provides one or more embodiments of one or more processor readable storage devices comprising instructions encoded thereon which instructions cause one or more processors to execute a method for authenticating a user based on data representing wrist vein pattern. Besides the method embodiment described above, additional embodiments of methods are described below.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary view of a vein pattern on a palmar side of a human wrist overlaid with an array of contact sensors of a sensor unit.

FIG. 2 illustrates an embodiment of a wrist wearable device including a wrist contact sensor device positioned by a wristband to contact the user's skin on a palmar side of a user's wrist.

FIG. 3A illustrates an exemplary 8×4 layout of IR photodetector sensors and IR illuminators for an embodiment of a wrist contact sensor device.

FIG. 3B illustrates an exemplary 32×10 layout of photodetector contact sensors interspersed with linear illuminators for another embodiment of a wrist contact sensor device.

FIG. 3C illustrates an exemplary 16×10 layout of photodetector contact sensors interspersed with linear illuminators for yet another embodiment of a wrist contact sensor device.

FIG. 4A is a block diagram of an embodiment of a system from a hardware perspective for authentication of a user based on data representing a wrist vein pattern of the user.

FIG. 4B is a block diagram of an architecture embodiment for the sensor interface circuitry interfacing with the contact sensors.

FIG. 4C is a block diagram of an embodiment of a system from a software perspective for authentication of a user based on data representing a wrist vein pattern of the user.

FIG. 4D is a block diagram of another embodiment of a system from a software perspective for authentication of a user based on data representing a wrist vein pattern of the user.

FIG. 5 is a flowchart of an embodiment of a method of authenticating a user based on data representing a wrist vein pattern.

FIG. 6A is a flowchart of an embodiment of a method for generating reference wrist vein pattern data accounting for translation and rotation of a wrist contact sensor device on a wrist.

FIG. 6B is a flowchart of another embodiment of a method of authenticating a user based on data representing a wrist vein pattern from a perspective of a wrist contact sensing system.

FIG. 6C is a flowchart of another embodiment of a method of authenticating a user based on data representing a wrist vein pattern from a perspective of one or more computer systems communicatively coupled to a wrist contact sensing system.

FIG. 7A illustrates an example of a three layer feed forward neural network.

FIG. 7B illustrates an example of a feature space illustrating three first principal components.

FIG. 8 illustrates a pulse waveform detected using a 16 sensor linear array.

### DETAILED DESCRIPTION

Besides security of computer access and data stored by a computer system, biometric authentication may also come in useful in other contexts to verify someone was at a place or is performing an activity such as exercise. Continuous authentication may also be useful, for example in military or other environments requiring high security or monitoring of activity over time. For example, during operations where exposures to chemical and biological threats are possible, a warfighter wears a Military Oriented Protective Posture (MOPP) suit. To allow the warfighter secure and efficient access to networked workstations, continuous authentication of the warfighter in the MOPP suit is desired. Additionally, a wearable wrist contact sensing system communicating with a base station provides authentication without explicit intervention from a user wearing the wrist contact sensing system. In another example, a user may be exercising on a machine and his or her wrist contact sensing system continuously authenticates the user based on his or her wrist vein pattern. A pulse reading in a military context may insure the wearer of the sensing system has not been killed and his wrist is being used post mortem. In an exercise or health monitoring situation, the additional pulse data can verify a health state of the user based on stored pulse data patterns representing various conditions or stored rules about changes reflected in the data.

The wrist is the carpus or joint between the forearm and the hand. Eight bones of the carpus and the distal ends of the radius and ulna form a complex articulation that allows three degrees of freedom. In order to provide the articulation while maintaining relative stability, the wrist has a complex configuration of ligaments linking the bones. The wrist also has a readily identifiable neurovascular structure. The primary pulsatile components in the wrist are the radial and ulnar arteries.

The wrist provides sufficiently distinct anatomical features that can be used for identification and authentication. Examples of some of these features in a wrist vein pattern are density of the veins, their positions, the paths or trajectories of the vein, how they branch, their diameter and even their brightness. It turns out that comparing data representing a wrist vein pattern with stored reference wrist vein pattern data generated from previous detections can be used to authenticate the identity of a user with an error rate of less than one in ten thousand (1/10,000) which for many applications is sufficient. An example of a stored reference wrist vein pattern is an image of the wrist anatomy obtained using diffusive optical tomography. This error rate was determined based on verification of authentication on 10,000 simulated vein images generated from a wrist-vein pattern simulator based on vasculogenesis.

The subcutaneous veins on the palmar side of a human wrist are visible to a human eye and usually appear blue. An advantage of working with subcutaneous anatomy is the ease with which features can be imaged using infrared (IR) illumination and in particular, near infrared (NIR) illumination. Near infrared illumination is about 850 nanometers (nm). A wrist contact sensor device comprises a plurality of infrared (IR) sensors positioned by a support structure for contacting skin of a user on a palmar side of the user's wrist. The sensors contact with the skin avoids scaling and perspective errors associated with IR cameras and reduces effects of ambient IR radiation. Because of the color of veins, which carry blood depleted of oxygen, an IR sensor receives and thus detects less IR reflections. The diminished or absence of reflections makes the wrist vein pattern. When the detector data is processed as image data, the veins data can be assigned values showing them as dark areas.

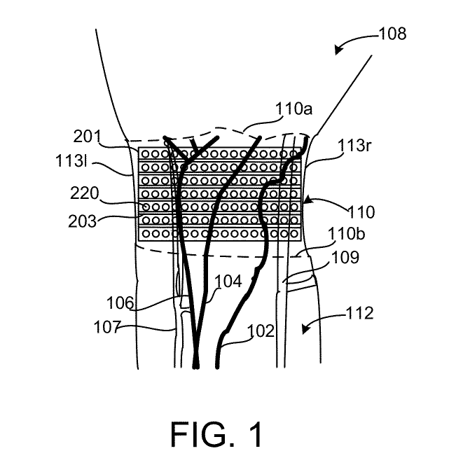

FIG. 1 illustrates an exemplary view of a vein pattern on a palmar side of a human wrist showing through an illustrative overlay of a wrist contact sensor device 201 including an array of skin facing contact sensors 220 with lines of illumination probes, also referred to as illuminators 203. One of each sensor 220 and probe 203 are labeled to avoid overcrowding the drawing. In many embodiments, the illuminators 203 also contact the skin. As noted above, the wrist is between the forearm 112 and the hand 108, and the skin area associated with the wrist, is illustrated as beginning between the forearm around 110b and the hand, beginning around 110a. (This figure is not drawn to scale.) Veins 102, 104 and 106 are exemplary components of a vein pattern under the skin of the wrist 110. Representative arteries 107 and 109 are also illustrated. In this embodiment, the sensors 220 are IR sensors which have more reflection from the arteries, and the reflections include high frequency components indicating a human pulse pattern over time. The wrist contact sensor device 201 is placed in contact with the skin over the palmar side of the wrist.

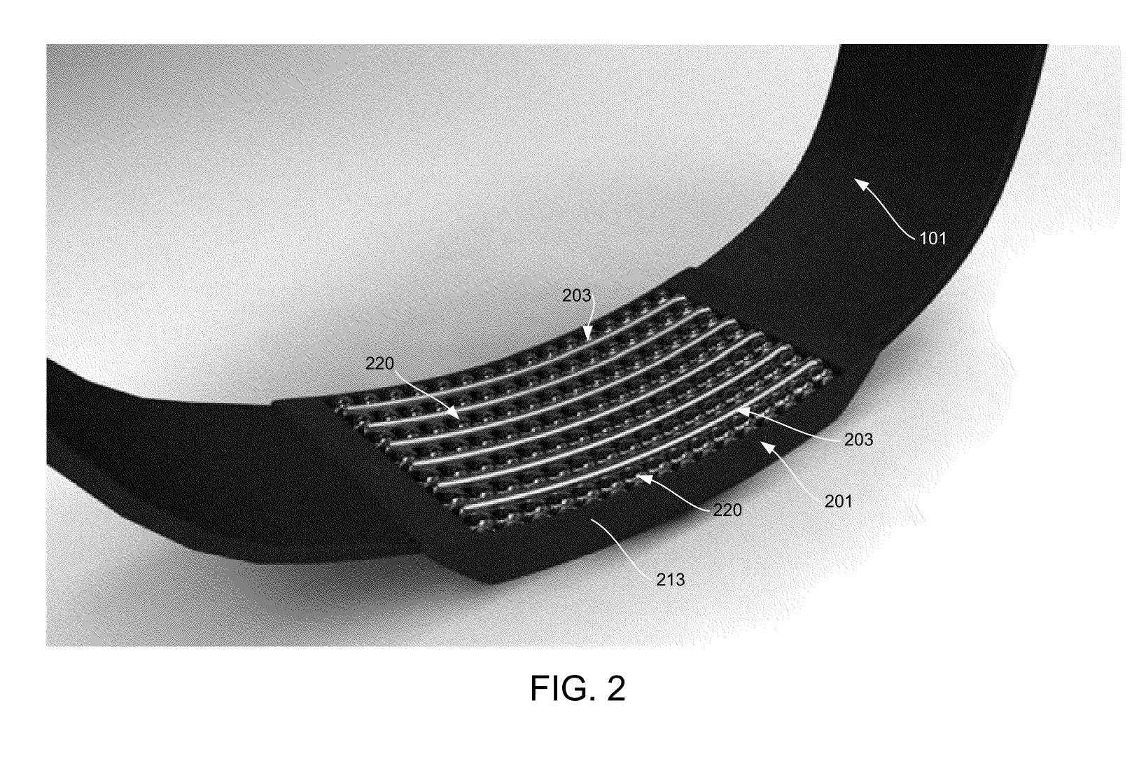

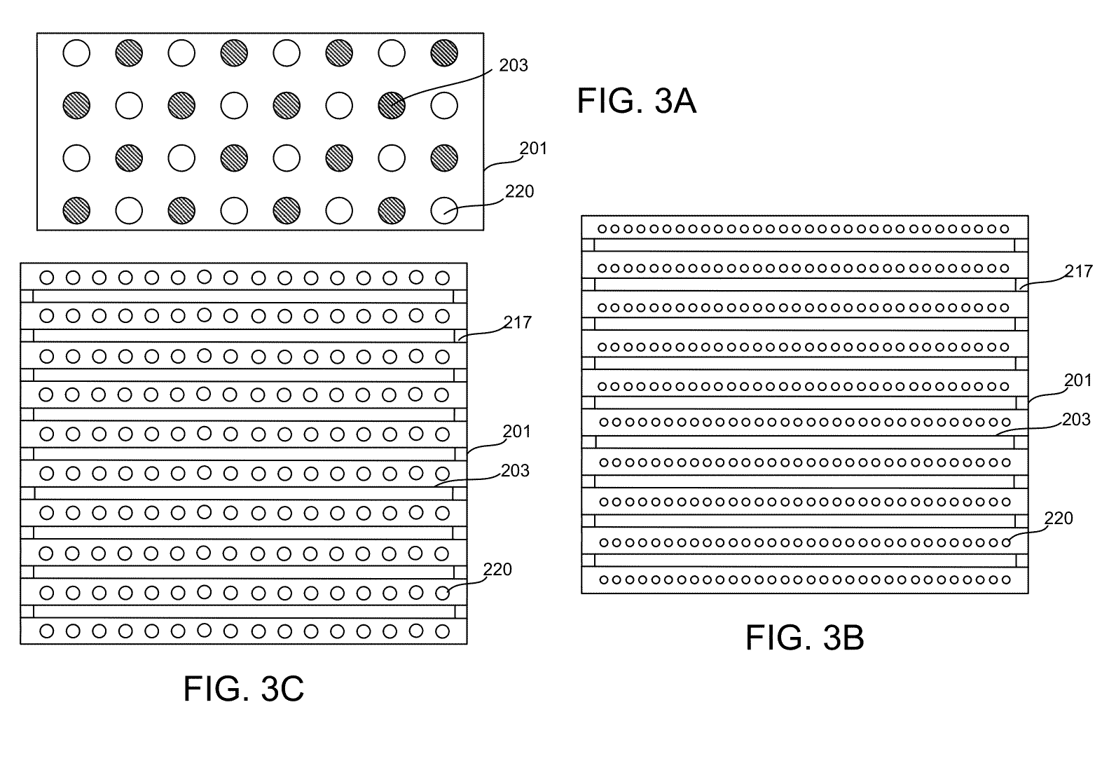

The skin area of the wrist is sufficiently planar or flat so that sensors can be arranged in a planar configuration in some examples or in a nearly planar nearly planar configuration (See FIG. 2) in other examples. The illuminators 203 produce illumination in the infrared spectrum which is directed into the skin of the palmar side of the wrist. In this example, near-infrared illumination (e.g. about 850 nm) is used. The contact sensors 220, which are infrared photodetectors, have a 16×7 array arrangement in this illustrative example. This sensor arrangement and the exemplary arrangements in FIGS. 3A, 3B and 3C have more sensors across the wrist skin along what is referred to as a horizontal direction than along a vertical direction. A horizontal direction extends in an approximately horizontal direction from a thumb side of the wrist to a pinkie finger side of the wrist or vice versa. For example, a horizontal direction may be from 113l to 113r or vice versa from 113r to 113l. A vertical direction extends from the hand to forearm or vice versa.

In this 16×7 example, the sensors have a separation of about 2 mm between each of them over a wrist region of about 32×10 mm. The size of the sensor array is driven by three factors primarily: capturing data for a large enough area, for example imaging a large enough area, to obtain sufficient discrimination of features; maintaining reliable contact between a sensor and the skin; and optimizing for wearability.

In other embodiments, illumination and reflections in wavelength bands besides infrared and near-infrared may be used, for example, other non-visible wavelength bands.

FIG. 2 illustrates an embodiment of a wrist wearable device including a wrist contact sensor device 201 positioned by a wristband 101 or wrist strap to contact the user's skin on a palmar side of a user's wrist. The wristband acts as a support structure positioning the wrist contact sensor device against the skin on the palmar side of a user's wrist. In other examples of a wrist wearable device, the support structure may be a bracelet. In some examples, the wrist strap or wristband may include the wrist contact sensor device as well as other modules like a computer system with a display in watch form factor. A computer system includes at least one processor and a memory. FIG. 2 is a CAD illustration showing a conceptual integration of the contact sensor array device into a wearable device.

A support structure or housing 213 of the device, e.g. a plastic support structure, supports the optical sensors 220 and illuminators 203 and provides a conduit for their electrical circuitry. A slight curvature of the sensor was designed based on a 3D model of various wrists. FIG. 2 shows the integration a 16×7 sensor array with rows of linear illuminators. The slight curvature of the sensor matrix enhances contact with the skin. A larger array, particularly one with more sensors along a horizontal direction versus a vertical direction, e.g. 32×10 as discussed further below, allows for higher authentication performance.

FIG. 3A illustrates an exemplary 8×4 layout of IR photodetector sensors 220 and IR illuminators 203 for an embodiment of a wrist contact sensor device. As the separation between an illuminator and a detector increases, the effective depth of the measured region of the wrist also increases. By having a large number of illuminator-detector pairs, image data representing the positions of the components of the anatomical structure in the wrist is obtained. In this example, the illumination probes, also referred to as illuminators, are part of an array of 16 illuminators 203 interspersed with 16 detectors 220. For illustrative purposes of an interspersed layout pattern, the illuminators have a slanted vertical line fill and the photodetector sensors 220 are not filled. The illuminators may be implemented with light emitting diodes (LEDs) or lasers, e.g. VCSELs.

In this example, a spherical lens for each detector or probe collimates the IR photons and provides a reliable contact with the skin. In one example, the diameter of each spherical lens is 0.8 mm. The array of detectors and illuminators with the spherical lens is encapsulated in this example with a light-blocking potting compound which prevents optical leakage through air. In this embodiment, the illuminators are illuminated one at a time for allowing control of the illuminator-detector separation, and the 16 detectors measure the intensity of the IR photons scattered by the anatomy in the wrist. Illuminating one at a time allows those detectors farthest from the illuminator currently turned on to detect photons which travelled deeper into the wrist providing better position data for the vein pattern being detected than if all the illuminators were turned on at once. Additionally, for continuous authentication, this illumination sequence of one at a time or others which do not have all the illuminators on at once, saves power.

A sensor array such as that in FIG. 3A may be used in obtaining the reference image data using diffusive optical tomography which can image deeper structures in the wrist. However, the veins close to the skin provide sufficiently unique structures for use as authentication features, and imaging the veins close to the skin can use much simpler sensor and illuminator configurations than configuration used for those imaging deeper structures in the wrist. In other examples, an infrared charge coupled device (CCD) camera may be used to obtain one or more reference images of a user's wrist and be stored in an accessible reference wrist vein pattern database. In some embodiments, for image comparison is used. The detection signals captured by the sensors 220 are converted to digital form and processed to digital image data. For comparison, a pixel size of reference image data is adjusted to match a pixel size represented by each sensor in an embodiment of a wrist contact sensor device. A reading associated with each contact sensor can be calibrated to a scale matching the encoding CCD sensors. An example of such a scale is 0 to 255. In other examples, data representing reference wrist vein patterns are obtained using the wrist contact sensor device itself, for example, as part of an initialization procedure.

FIG. 3B illustrates an exemplary 32×10 layout of photodetector contact sensors 220 interspersed with lines illuminators for another embodiment of a wrist contact sensor device 201. In this example, the 32×10 sensor array images or detects data for a 32×19 mm area. For a resulting 32×10 pixel image, there results about a 1 mm pixel pitch with 0.8 mm pixel size. In an example for a 16×7 sensor array, a 32×20 mm area may be imaged or data captured for. For a resulting 16×7 pixel image, the result is about a 2 mm pixel pitch and about a 1.6 mm pixel size. Light blocking potting compound surrounds the sides of each detector to prevent optical leakage through air for portions of the detector which may not be in contact with the skin.

FIG. 3C illustrates an exemplary 16×10 layout of photodetector contact sensors 220 interspersed with lines illuminators 203 for another embodiment of a wrist contact sensor device 201 also detecting data for about a 32×19 mm area or 32×20 mm area. The pixel pitch and size may be adjusted accordingly in view of the parameters for the 16×7 and 32×10 examples.

The embodiments of the wrist contact sensor device 201 of FIGS. 1 and 3B each use a linear detector array with an illuminator 203 that simultaneously provides infrared illumination, reflection of which by anatomical structures in the wrist like the subcutaneous veins, are available for all the photodetectors in the array to detect. Illumination drive circuitry and sensor interface electronic circuitry are illustrated at positions 217 in this example and may extend (not shown) at the back of the sensors 220 and illuminators 203. Due to the wrist contact sensor device being close to the skin, controlled spatial separation of the illumination beams is unnecessary. The illustrated linear illuminator 203 may be embodied as a light diffuser backlighted by one or more light emitting diodes LEDs. In other examples, a laser source with its beam diffused by a diffuser may be used. In other examples, each illumination row 203 may embody one or more LEDs or lasers.

A key advantage of the contact sensors over cameras is that there are no scaling or perspective errors. Any information on the dimensions of the identifiable features as well as the distance between the features can thus be used by one or more pattern recognition techniques implemented by a computer system for automatic authentication of a user. Translations and rotations of data derived from the photodetectors are possible, however, and their effects are taken into account. For example, as discussed further below, data representing a wrist vein pattern can be captured at a number of reference positions on the wrist representing changes in translation and rotation from at least one of the reference images.

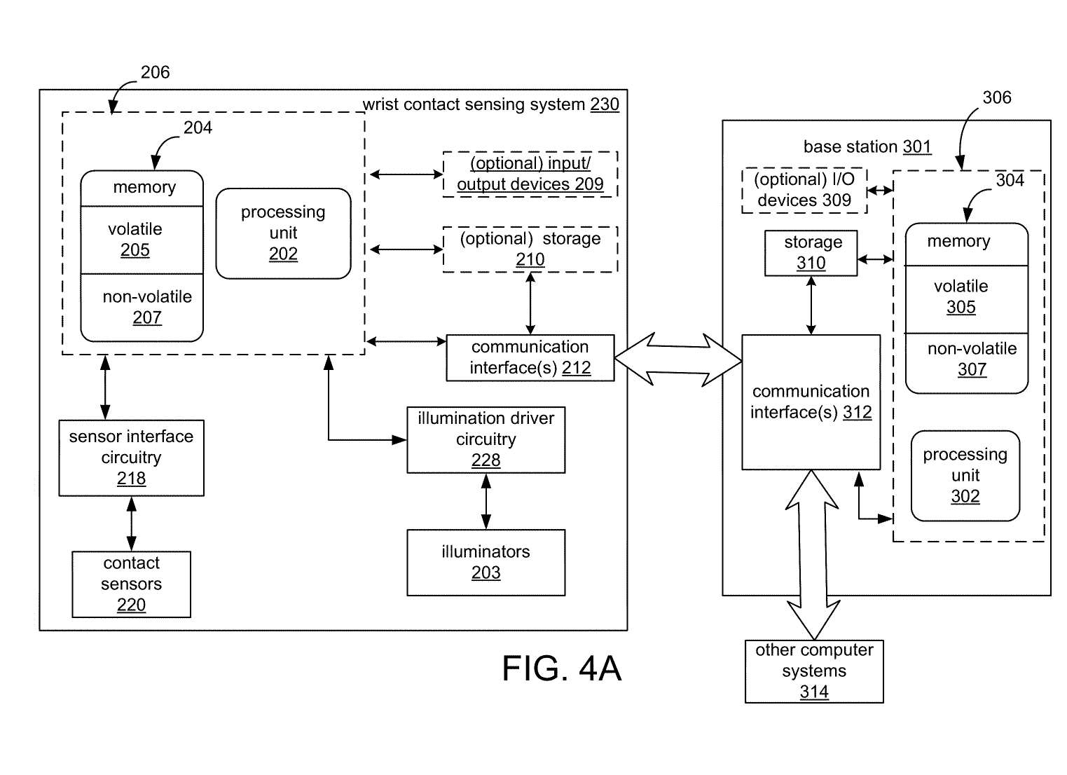

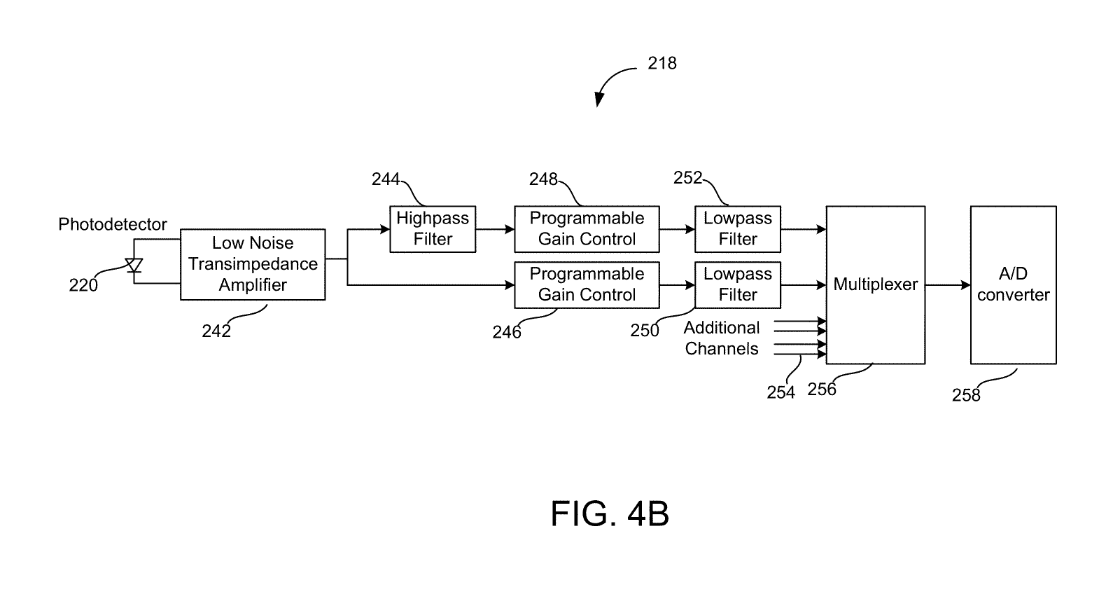

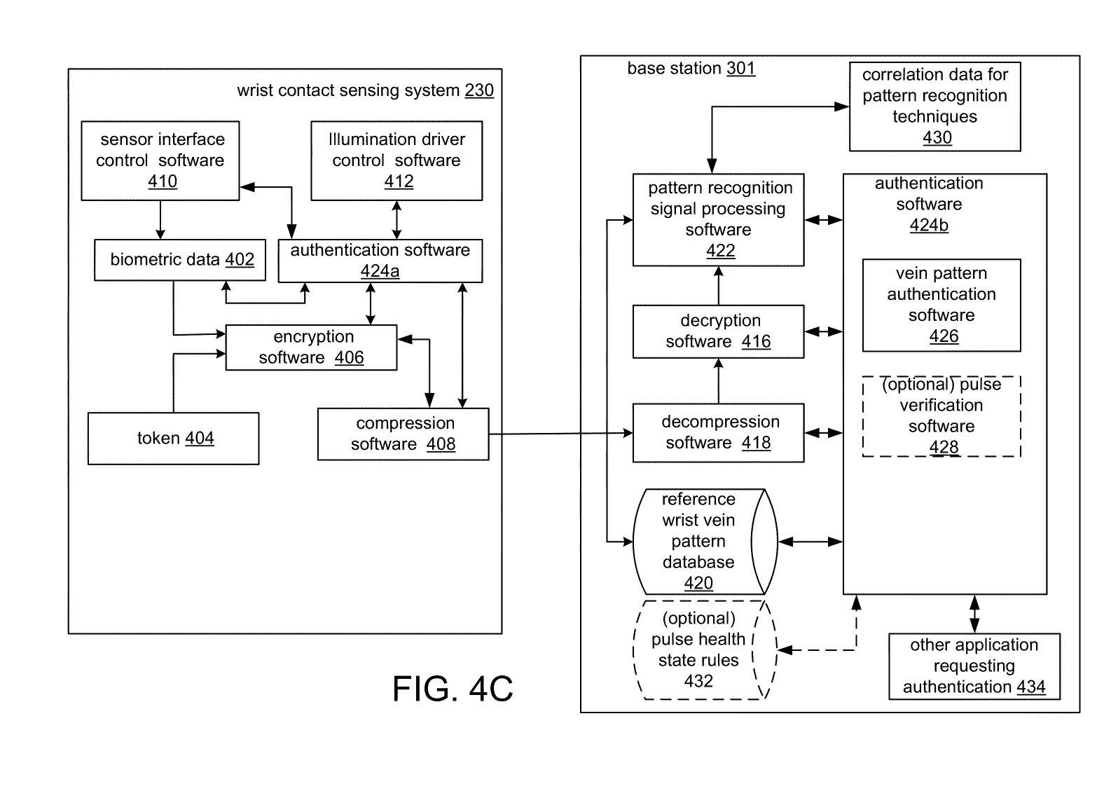

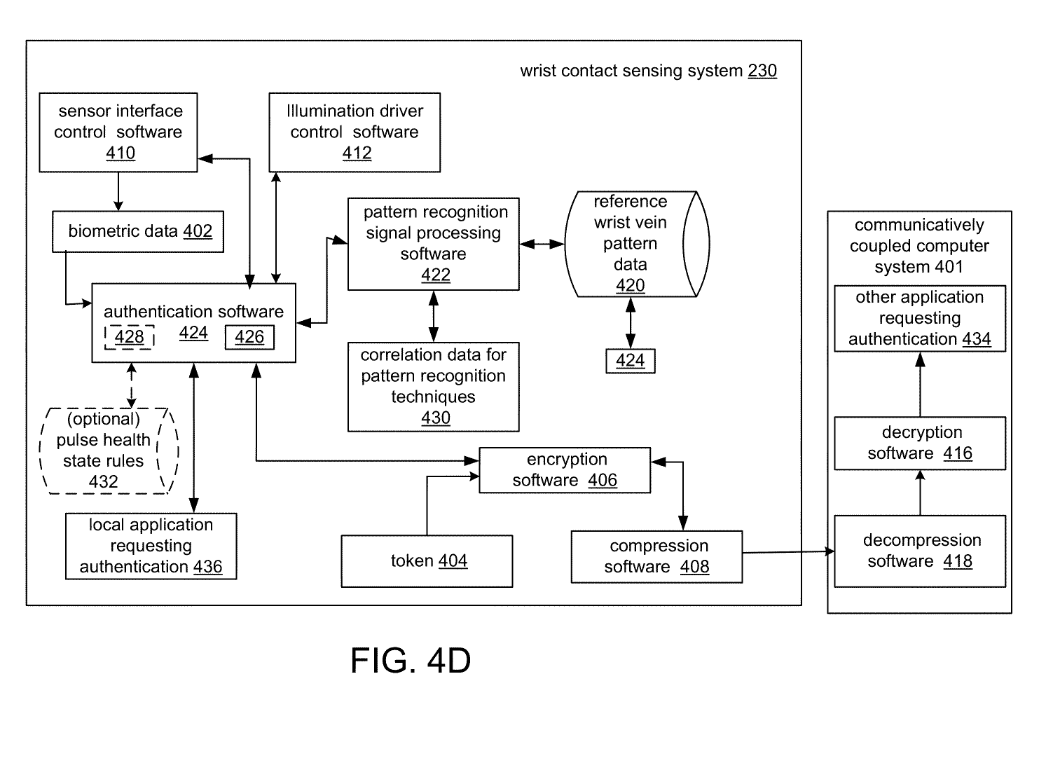

FIG. 4A is a block diagram of an embodiment of a system from a hardware perspective for authentication of a user based on data representing a wrist vein pattern of the user. A wrist contact sensing system 230 is communicatively coupled to a computer system (301, 314) over a communication network. In this example, the wrist contact sensing system 230 may be embodied in a wearable device and is networked via a wireless communication link to a base station 301 computer system. In other examples, a wrist contact sensor device 201 comprising the illuminators 203, contact sensors 220, illumination driver circuitry 228 and sensor interface circuitry 218 may be mounted on a physical structure attached near a door entry or an exercise machine. A user may place his or her wrist against the physical structure and the sensor interface circuitry 218 communicates the sensor readings to the processing unit 202 for further processing. This system embodiment and other system embodiments described below may be used for one-time authentication or for continuous authentication during user activity.

In other examples, a radio communication range between a wearable wrist contact sensing system 230 and the base station 301 may be engineered to provide a well defined region of operation. Since the wearable system, e.g. supported on a wristband, is physically bound to the user, the limited radio range of the system 230 ensures that the user is within a secured region around the base station. When the link between the base station and the wearable device is broken, the base station recognizes that the user is absent and notifies one or more applications requesting authentication. For example, an application executing on the base station or a computer system 314 in communication with the base station 301 may cut off access to sensitive data. An identifier token may be used to establish a communication link between the contact sensor device 201 and the base station 301.

In the illustrated example of FIG. 4A, the wrist contact sensing system 230 includes a computer system 206 including a processing unit 202 including one or more central processing units (CPU) or microcontrollers and a memory 204 for storing software and data which may include volatile memory 205 (such as RAM), non-volatile memory 207 (such as ROM, flash memory, etc.) or some combination of the two. Additional memory storage 210 (removable and/or non-removable) may also be included in the sensor system for access by the computer system 206 and in some examples the sensor interface circuitry 218 for storing sensor readings digital data. One or more communication module(s) 212 include one or more network interfaces and transceivers which allow the wrist contact sensor device 201 to communicate with other computer systems typically wirelessly but also through wire if a wire interface is included. In some instances, direct memory access (DMA) such as to a buffer in the optional additional memory storage 210 may be supported for an interface of at least one of the communication modules 212. Optional input devices 209 like a touch screen and buttons on a watch display attached to a wearable support structure and optional output devices 209 like a display collocated on the same wearable support structure may also communicate with the processing unit 202 and memory 204.

The wrist contact sensing system 230 also comprises illumination drive circuitry 228 which drives the one or more illuminators 203 with current or voltage under the control of the processing unit 202. Sensor interface circuitry 218 is coupled to the sensors 220 for converting their analog detection signals to digital data which are stored by the processing unit 202 in memory (205, 207, 210). The processing unit 202 may process the digital data further to be in a format usable by a pattern recognition technique for determining an identity of a user. The processing unit 202 may also monitor the operational status of the illuminators and sensors based on monitoring detected data and component status data received from the sensor interface circuitry 218 and the illumination drive circuitry 228.

In some wearable embodiments of the wrist contact sensing system 230, a wrist contact sensor device includes at least the sensors 220, the illuminators 203, illumination driver circuitry 228, and sensor interface circuitry 218 and is positioned on a wrist wearable structure for contact with the palmar wrist skin. A wire through the wearable structure may connect the wrist contact sensor device to the processing unit 202 and perhaps the memory 204 which are housed in a watch form factor device or structure on the wearable structure as well. In some embodiments, the wrist contact sensor device 201 embodies the wrist contact sensing system 230 within its housing 213 by including other elements like the processing unit 202, the memory 204 and the communication interfaces 212 within its housing 213. It may have input and output device capabilities in some embodiments as well.

The base station 301 also includes a computer system 306 with a processing unit 302 including one or more processors and a memory 304 which may include volatile 305 and non-volatile 307 memory components. Additional storage 310 is available. Similarly, the base station 301 includes one or more communication module(s) 312 which include one or more network interfaces and transceivers which allow the base station to communicate with the wrist contact sensing system 230 and other computer systems 314 over wire or wirelessly or in both manners. In some embodiments, the base station may also include optional input and output (I/O) devices 309 like a display and buttons, touchscreen or a keypad, pointing device, keyboard or the like.

To avoid cluttering the drawings, a power supply and power bus or power line is not illustrated, but each of the system embodiments illustrated from a hardware perspective also includes or has access to a power supply, for example via a power bus to which the various components using power connect for drawing power. An example of a power supply is a battery. Larger computer systems such as the base station and other networked computer systems may also have a power cord connection.

The example computer systems illustrated in the figures include examples of computer readable storage devices. A computer readable storage device is also a processor readable storage device. Such devices may include volatile and nonvolatile, removable and non-removable memory devices implemented in any method or technology for storage of information such as computer readable instructions, data structures, program modules or other data. Some examples of processor or computer readable storage devices are RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other device which can be used to store data in place by fixing the data in one or more memory locations which can be accessed by a computer.

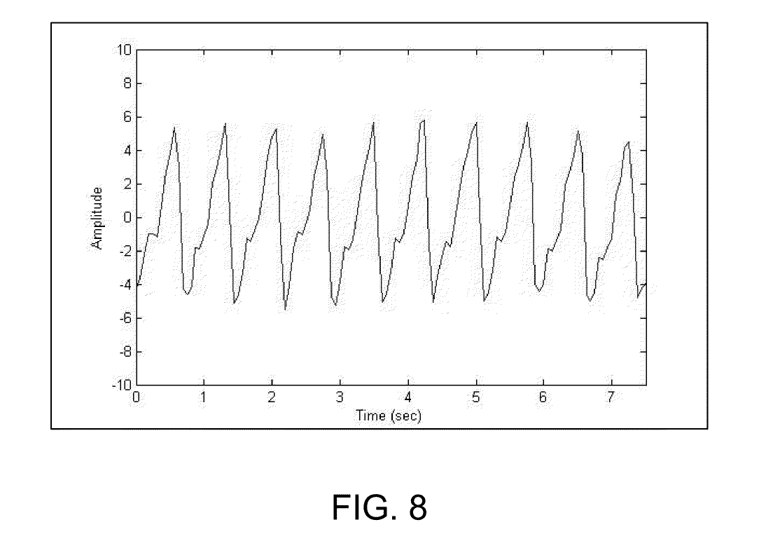

In addition to analyzing the anatomy in the wrist and in particular, the wrist vein pattern, the location and intensity of pulsatile components can be analyzed to enhance authentication performance. FIG. 8 illustrates a pulse waveform detected using a 16 sensor linear array. While the linear array is not optimized for pulse detection, it is still able to resolve the dicrotic notch in the pulse waveform. Additionally, the continuity of the pulse can be used to determine if any adverse events were forced onto the subject (e.g. forced removal of device, cardiac arrest) during the continuous authentication period. Pulse analysis can also provide information on the physiological condition or health state of the wearer that can be optionally incorporated into the authentication algorithm.

FIG. 4B is a block diagram of an architecture embodiment for the sensor interface circuitry 218 interfacing with the contact sensors 220. In this embodiment, the sensor interface circuitry 218 comprises circuitry for separating pulsatile components from non-pulsatile components in the detection signals being received from the sensors. The IR sensors detect the pulse in the arteries 107 and 109 and the detection signals include high frequency signals representing the pulse. In this example, each sensor 220 is a photodetector 220 which generates an electrical detection signal based on the IR photons representing IR reflections it detects. Each detection signal generated by this photodetector is received by a low noise transimpedance amplifier 242 which amplifies the signal. The signal is electrically split so that part of the signal goes through a high pass filter 244 which passes through high frequency pulsatile components in the detection signal before going through a programmable gain control 248 and a low pass filter 252.

The other portion of the amplified detection signal has its gain adjusted as necessary based on parameters stored for the programmable gain control 246 and also goes through a lowpass filter 250. The gain for the high frequency components and the signal portion which is not high pass filtered may be different as well as the cutoff frequencies for the lowpass filters 250 and 252. Lowpass filter 252 has a higher frequency cutoff to maintain pulsatile components as lowpass filter 250 is removing the high frequency pulsatile components. A multiplexer 256 receives the signal including pulsatile components and the signal with non-pulsatile components on different channels. The multiplexer 256 may multiplex signals from different photodetectors on different channels and multiplex the use of the analog-to-digital converter 258 in generating digital data representing each sensor detection signal as a sensor reading. In some of the examples below, sensor readings may be processed directly for pattern recognition techniques. In other examples, the data may be correlated to different values, e.g. scaled intensity values 0 to 255, which may be used for some types of pattern recognition techniques.

FIG. 4C is a block diagram of an embodiment of a system from a software perspective for authentication of a user based on data representing a wrist vein pattern of the user. In this example, pattern recognition techniques are applied by a computer system with which the wrist contact sensing system 230 communicates over a network and which computer system, the base station 301 in this example, has either locally stored or has access via a network to a reference wrist vein pattern database 420.

In this example, a version 424a of authentication software communicates with the illumination drive control software 412 and sensor interface control software 410 to detect events which may indicate either a sensor or illuminator or both are malfunctioning. Additionally, the sensor interface control circuitry stores the sensor readings digital data from the sensor interface circuitry as biometric data 402 and notifies the authentication software 424a. As per the discussion above, the biometric data may include the pulse data readings separated from the digital data representing the detection signals which include digital data representing a wrist vein pattern. Upon notification from the authentication software 424a, the biometric data 402 is encrypted with a token 404 or key by encryption software 406 and compressed by compression software 408 before the authentication software 424a causes the processing unit 202 to communicate the encrypted biometric data over a communication network link to another computer system, base station 301 in this embodiment.

This example and the example in FIG. 4D illustrate the use of compression and decompression, but other embodiments may not compress and decompress the data. In some embodiments, encryption may not be used, for example, when authentication is processed in a same unit or device which does the sensing.

On the base station side, decompression software 418 decompresses the incoming compressed biometric data 402 which is decrypted by software 416 which notifies the signal processing version 424b of the authentication software 424 of the arrival of new biometric data including wrist vein pattern data. Processing of the pulse data is optional, but can be used as an indicator to detect the system is being corrupted with images not sent from a user or are being sent from a dead user. The pulse data may also provide a health state of the user. The authentication software 424b may include vein pattern authentication software 426 and optionally, pulse verification software 428 which can identify a health state of being alive as well as detecting other health states like a heart attack or pulse irregularities indicating other health conditions as identified by health state rules 432.

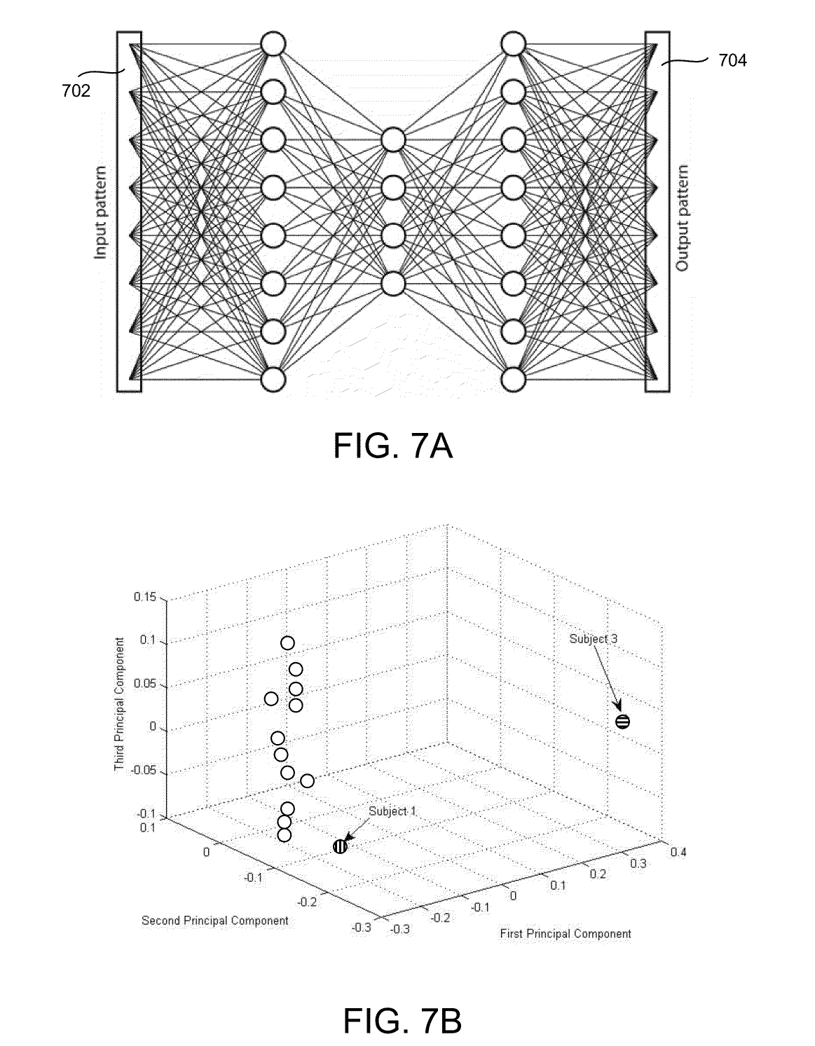

The vein pattern authentication software 426 may display data of instructions to a user during an initialization state of the wrist contact sensing system 230 for generating reference wrist vein pattern data which is then stored for the user in the reference wrist vein pattern database 420. The reference patterns are generated using one or more pattern recognition techniques supported by the pattern recognition signal processing software 422. The authentication software 424 causes the pattern recognition signal processing software 422 to put the incoming biometric data representing a wrist vein pattern into a pattern recognition technique data form (see discussion of FIGS. 7A and 7B) which correlates with the one or more pattern recognition technique data forms of the reference wrist vein patterns. For some techniques, e.g. imaging techniques as the sensor arrays may be considered imaging devices, the signal processing software 422 refers to stored correlation data 430 for pattern recognition techniques for lookup tables which correlate sensor readings data to values like image intensity values (e.g. 0 to 255) or other scaled values.

Based on a match with a reference wrist vein pattern satisfying matching criteria, a user identity stored for the reference pattern is assigned for the user and communicated to one or more other applications 434 requesting user authentication.

FIG. 4D is a block diagram of another embodiment of a system from a software perspective for authentication of a user based on data representing a wrist vein pattern of the user. In this example, the comparison with a reference pattern is performed by the wrist contact sensing system 230. For example, reference wrist vein pattern data for just the user may be stored locally in memory 204 or other storage 210. There may be instances where a wrist contact sensor device 201 or a wrist wearable wrist contact sensing system 230 including it is desired to be limited to one or a few people. The token can also be used to identify a device 201 or wearable system 230 and its owner or permitted user. As illustrated in FIG. 4D, the pattern recognition processing software 422 executes and reference wrist vein pattern data 420 is stored in the wrist contact sensing system 230. The authentication software 424 can authenticate the user for a local application 436 or for a requesting application 434 executing remotely across a network. The authentication software 424 can send a message indicating whether the detected data from the wearer matched an identity in its reference wrist vein pattern data 420. Health state processing may also be performed in line with the discussion above.

In some embodiments, one or more computer systems, like a combination of two or more of the base station 301, other computer systems 314, and the wrist contact sensing system 230 may share authentication and health state processing based on the detected data.

The method embodiments are discussed for illustrative purposes in the context of the system embodiments discussed above. However, the method embodiments may also be practiced in other system embodiments as well.

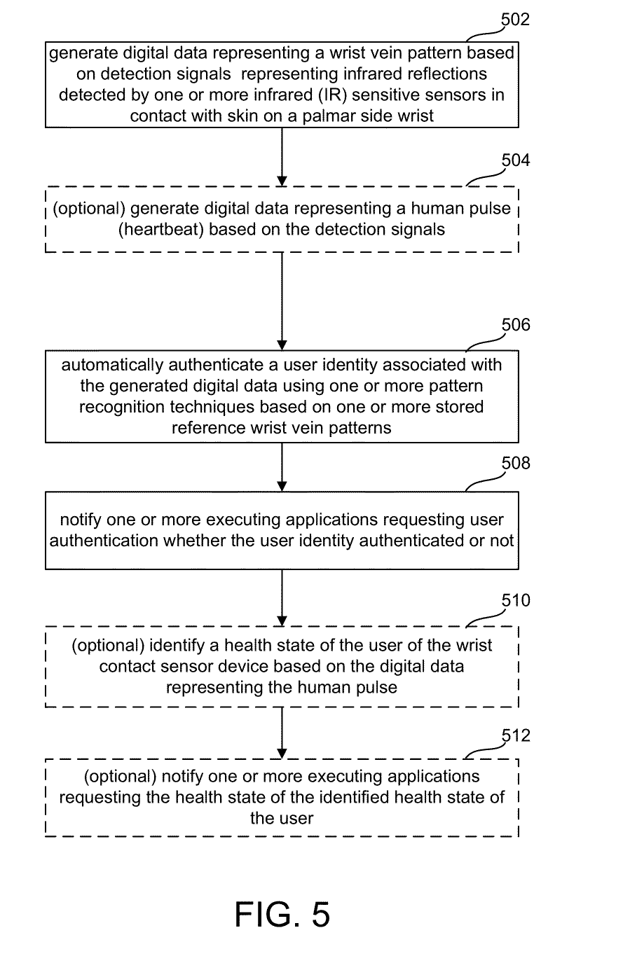

FIG. 5 is a flowchart of an embodiment of a method of authenticating a user based on data representing a wrist vein pattern. In step 502, the wrist contact sensing system 230 generates digital data representing a wrist vein pattern based on detection signals representing infrared reflections detected by one or more infrared (IR) sensitive sensors in contact with skin on a palmar side wrist. As illustrated in FIG. 4B, optionally, the wrist contact sensing system 230 in step 504 may generate digital data representing a human pulse, a heartbeat, based on the detection signals. In the examples above, the sensor interface circuitry 218 converts the analog signals from the photodetectors 220 to data in a digital form. Preprocessing like scaling, smoothing, and putting into vector formats of this data may occur to put it in a form for comparison with stored reference wrist vein patterns or application of the health rules. In step 506, the authentication software 424 executing in a processing unit 202, 302, 314 of a computer system having access to reference wrist vein pattern data (e.g. 420 automatically authenticates a user identity associated with the generated digital data using one or more pattern recognition techniques based on one or more stored reference wrist vein patterns.

In step 508, the authentication software 424 notifies one or more executing applications requesting user authentication whether the user identity is authenticated or not. Optionally, in step 510, the pulse verification software 428 of the authentication software may identify a health state of a user of the wrist contact sensor device 201 based on the digital data representing the human pulse. For example, the pulse software may execute logic of the health state rules with respect to the human pulse data for identifying the health state. In optional step 512, the pulse software 428 notifies one or more executing applications requesting the health state of the identified health state of the user.

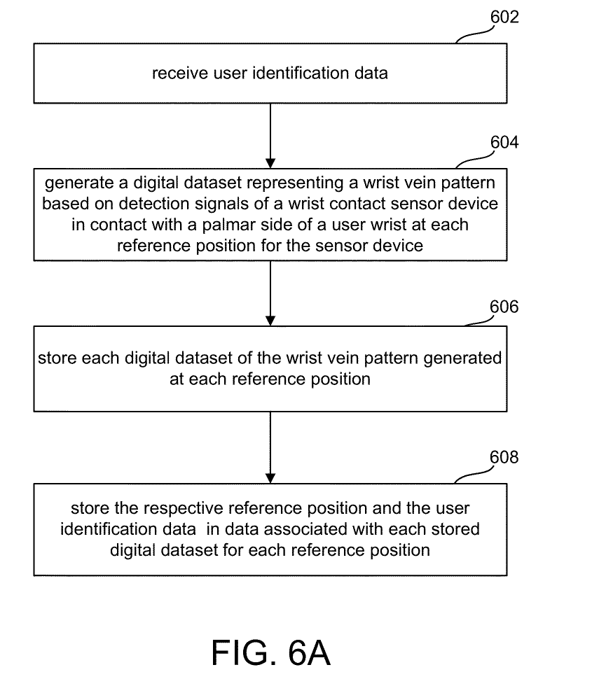

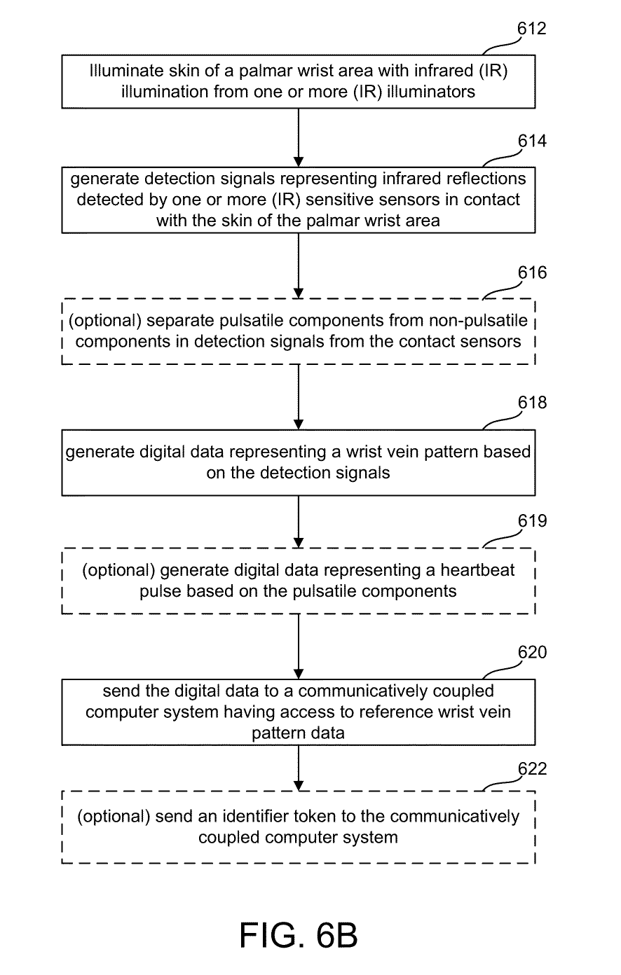

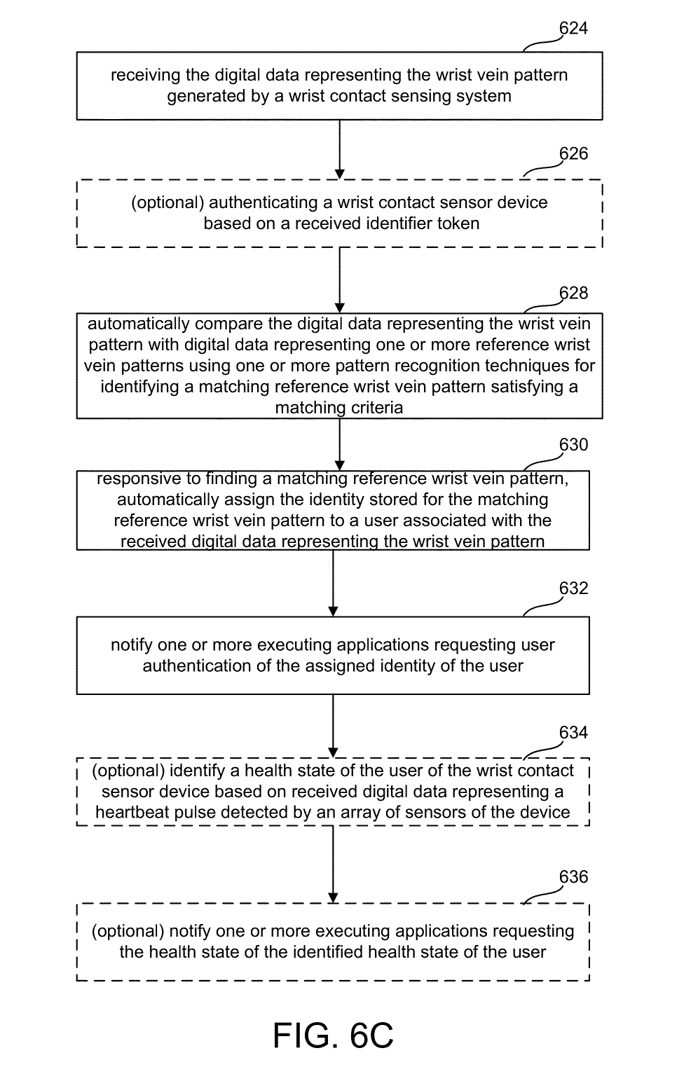

FIG. 6A is a flowchart of an embodiment of a method for generating reference wrist vein pattern data accounting for translation and rotation of a wrist contact sensor device on a wrist. In step 602, authentication software 424 receives user identification data. Some examples of user identification data may be a username and password input by a user on a screen of a computer system communicatively coupled to the wrist contact sensor device 201 which may include another computer system on the same wristband, e.g. one in a watch form factor on the wristband. The user identification data may also be encrypted with the token or form part of the token.

The authentication software displays instructions to a user on which positions to move the wrist contact sensor device 201 on his or her wrist. An accelerometer or inertial sensor on the wearable support structure may assist the authentication software 424 in identifying when a reference position has been reached. Additionally, tracking changes in the detected data may identify the translation and rotation, and the authentication software 424 may cause a display e.g. (209) on the wearable support or a display (e.g. 309) on a communicatively coupled and nearby computer system to indicate to the user that a reference position has been reached.

In step 604, the wrist contact sensing system 230 generates a digital dataset representing a wrist vein pattern based on detection signals of a wrist contact sensor device 201 in contact with a palmar side of a user wrist at each reference position for the sensor device 201, and the authentication software 424 in step 606 has stored each digital dataset of the wrist vein pattern generated at each reference position, for example in a reference wrist vein pattern database 420. In step 608, the respective reference position and the user identification data is stored in data associated with each stored digital dataset for each reference position.

FIG. 6B is a flowchart of another embodiment of a method of authenticating a user based on data representing a wrist vein pattern from a perspective of a wrist contact sensing system 230 communicatively coupled to another computer system. In step 612, one or more illuminators 203 illuminate skin of a palmar wrist area with infrared (IR) illumination from one or more (IR) illuminators. One or more IR sensors, e.g. photodetectors 220, in step 614 generate detection signals representing infrared reflections detected by one or more (IR) sensitive sensors in contact with the skin of the palmar wrist area. Optionally, in step 616, the sensor interface circuitry 218 separates pulsatile components from non-pulsatile components in detection signals from the contact sensors. In step 618, the wrist contact sensing system 230 generates digital data representing a wrist vein pattern based on the detection signals. Optionally, in step 619, the wrist contact sensing system 230 generates digital data representing a heartbeat pulse based on the pulsatile components. In some embodiments, the digital data generated and sent may be the digital data generated by the sensor interface circuitry 218, and in other embodiments, some preprocessing of the digital data generated by the circuitry 218 may be performed by software 424, 426 executing in the wrist contact sensing system 230 to put the data in another form for further processing in the overall authentication process.

In this embodiment, the wrist contact sensing system 230 sends in step 620 the digital data to a communicatively coupled computer system having access to reference wrist vein pattern data. Optionally, in step 622, an identifier token is sent to the communicatively coupled computer system. The identifier token may identify the wrist contact sensor device 201 used, the wrist contact sensing system 230 used or even user identification data input from a user, e.g. username and password.

FIG. 6C is a flowchart of another embodiment of a method of authenticating a user based on data representing a wrist vein pattern from a perspective of one or more computer systems communicatively coupled to the wrist contact sensing system 230. In step 624, the one or more computer systems receives the digital data representing the wrist vein pattern from a wrist contact sensing system 230. Authentication software on the computer system optionally in step 626, authenticates a wrist contact sensor device based on a received identifier token. The token may identify the wrist contact sensor device 201 directly or as part of a wrist contact sensing system 230 identified in the token. The authentication software 424 executing on the one or more computer systems in step 628, automatically compares the digital data representing the wrist vein pattern with digital data representing one or more reference wrist vein patterns using one or more pattern recognition techniques for identifying a matching reference wrist vein pattern satisfying a matching criteria.

In step 630, responsive to finding a matching reference wrist vein pattern, the authentication software 424 automatically assigns the identity stored for the matching reference wrist vein pattern to a user associated with the received digital data representing the wrist vein pattern, and in step 632 notifies one or more executing applications requesting user authentication of the assigned identity of the user. Optionally in step 634, a health state of the user of the wrist contact sensor device 201 is identified based on received digital data representing a heartbeat pulse detected by the array of sensors 220, and optionally in step 636, one or more executing applications requesting the health state of the identified health state of the user is notified.

Different pattern recognition techniques may be performed to discriminate between wrist vein patterns obtained from different wrists. Principles and some implementation guidelines are described below for three examples: artificial neural networks (ANN), principal component analysis (PCA) and cross-correlation analysis (CCA).

Artificial Neural Networks

Neural networks have been widely used for pattern matching. For the specific goal of identifying wrist veins, a three layer feed-forward neural network may be used. FIG. 7A illustrates an example of a three layer feed forward neural network. This network is trained to reproduce a facsimile of input pattern 702 at the output, e.g. output pattern 704. In the authentication process, a wrist vein pattern is input to the network. The similarity between the input and the output is evaluated by neural network software (e.g. 422) using a similarity metric such as mean square error (MSE). A threshold for the mean square error is used for establishing a decision boundary or matching criteria to separate patterns that come from the wrist of one person from patterns that come from the wrist of other persons.

If the error is low enough to satisfy the threshold, the presented pattern is identified as a match with the reference pattern. A pattern different from one or more reference wrist vein patterns obtained for a user during training results in the input pattern not reproducing itself at the output, and a MSE error above the threshold is expected.

An array of signals from the infrared sensors, e.g 16×7, 16×10 or 32×10, is used to generate a single vector of signals which is formed by concatenating together the rows of the array (each row having 16 readings in the 16×7 example). This vector is used as a training pattern for the neural network. Several training patterns are generated from the wrist of the designated person.

These patterns are obtained by shifting (translating) the array of sensors up and down as well as left and right around the most likely position on the wrist where the array is going to be placed. The idea behind these translations is to allow the neural network to recognize the wrist vein pattern even if the wrist band shifts in position. This way the pattern matching task is invariant to translation of the array of sensors. Similarly, additional training patterns are generated by rotating the array in the clockwise and counterclockwise directions for obtaining invariance to rotation. In one training example, the wrist vein pattern is shifted by 5 mm and 10 mm in each direction, which generates 9 patterns (including the non-shifted pattern). Additionally, the pattern is rotated 5 degrees clockwise and counterclockwise. Thus, a total of 18 training vectors is generated.

In one example, the neural network structure has three layers with 500 neurons in the first layer, 50 neurons in the second layer and 320 neurons in the third layer. The Neural network training method was based on gradient descent back propagation. To test if a given input pattern vector belongs to the designated person, the vector associated with that pattern is presented to the trained neural network by the neural network software signal processing software (e.g. 422) and the executing software computes the mean square error between the input and the output. If this error is above the threshold, an authentication failure notice is sent to the authentication software; otherwise, a message indicating an authentication success and the identity of the user is sent to the authentication software 424 which notifies an application requesting user authentication by wrist vein pattern matching.

Principal Component Analysis

Principal component analysis is another widely used method to perform pattern recognition. In this case, the approach is to map the pattern vector to a feature space. The mapping is performed by first calculating the basis vectors of the feature space. For this purpose a group of input pattern vectors, called training vectors hereafter, are determined and their covariance matrix calculated by principal component analysis software, for example embodied in the signal processing software 422. The basis vectors of the feature space are obtained by computing the eigenvectors of the covariance matrix formed by the training vectors.

A key idea behind principal component analysis is that it allows obtaining the components of a pattern vector in the new feature space ranked by their order of importance. The order of importance is determined by the amount of variance that a specific component generates across a group of training vectors. This way, it is possible to focus only on the principal components (the ones with higher importance) of the group of training patterns when performing pattern matching tasks.

To determine if a given input pattern vector is similar to a group of training patterns, the input pattern vector is transformed by the software into the feature space of the training patterns. Once in the feature space, the Euclidian distance is computed between the transformed input vector and each of the training vectors. In situations where the input pattern is similar to the training patterns, the Euclidian distance should be small. If the input pattern is very different, then the Euclidian distance should be large. This happens precisely because the input pattern has very different features than those of the training group and this translates to a mapping point that is far away from the group.

FIG. 7B illustrates an example of a feature space illustrating three first principal components and provides an illustration of the pattern discrimination process performed through principal component analysis. For illustration, shown is a feature space generated by considering the first 3 principal components of the training data. The 12 empty circles in this figure show the position in feature space of 12 training patterns used for discrimination purposes. The circle with vertical line fill shows the feature space position of the data obtained in the validation phase for the reference wrist (Subject 1 or user 1). The circle with horizontal line fill shows the feature space position of the data from another user (Subject 3 or user 3). As can be observed, the distance from the vertical fill circle position to any of the empty circle positions is much smaller for subject 1 than it is for subject 3. Thus we have a practical margin to discriminate between these two subjects when performing discrimination.

Similar to the method used for neural networks, it is possible to establish a decision threshold as a matching criteria that allows separating between input patterns that are different and those that are similar to the training patterns.

The training vector was generated by concatenating together the rows of the array of infrared sensors in a way similar to that described for the neural networks. Multiple training vectors were also generated for the designated person by shifting the sensor array up/down and right/left, as well as by performing clockwise and counterclockwise rotations.

To test if a given input pattern vector belongs to the designated person, that vector is transformed into the feature space by the software 422 and the Euclidian distances are calculated to each of the training vectors (which are also in the feature space). From the set of computed distances, the principal component analysis software 422 takes the smallest value and compares it to the decision threshold. If the smallest distance is higher than the threshold, there is not a match, otherwise there is a match.

Cross Correlation Analysis

Cross correlation analysis allows a direct comparison of two wrist vein patterns, providing a measure of the similarity between the patterns. The sensor readings are represented by two dimensional arrays. Reference wrist vein patterns are generated for the designated person in a method similar to those used for the two previous methods, by performing rotations and translations.

Each sensor's detected data may be processed to represent a pixel in an image, for example a 16×7 pixel image of the vein pattern may result from the 16×7 sensor array.

To test if a given input pattern belongs to the designated person, two bi-dimensional arrays are used by cross correlation analysis software 422, one array corresponds to one of the reference patterns and another corresponds to the presented input pattern. The two arrays of readings are shifted and the following formula is computed at each shift by the cross correlation software.

CorrOutput(u,v)=Corr(F,T,u,v)−Corr(T,T,u,v) (1)

The definition of Corr(F,T,u,v) is given by

$$Corr ( F , T , u , v ) = \frac{{\sum }_{x , y} [ F ( x , y ) - {\overline{F}}_{u , v} ] [ T ( x - u , y - v ) - \overline{T} ]}{{\{ {\sum }_{x , y} {[ F ( x , y ) - {\overline{F}}_{u , v} ]}^{2} {\sum }_{x , y} {[ T ( x - u , y - v ) - \overline{T} ]}^{2} \}}^{0.5}} \qquad ( 2 )$$

Equation (1) shows the correlation output in terms of the variables u,v, which represent the shift between the arrays that are being compared in the X and Y directions respectively. The reference wrist vein pattern array is represented by T and the array corresponding to the given input pattern is represented by F. Equation (2) represents the definition of the function Corr(F, T, u, v). In this equation F(x,y) represents a pixel value assigned for the sensor reading at the x,y position within the sensor array for the given input pattern. Similarly T(x,y) represents a pixel value assigned for the sensor reading for the reference wrist vein pattern, and F̅_{u,v} represents the mean of F(x,y) in the region under the reference wrist vein, and T̅ represents the mean of the reference wrist vein.

The resulting values obtained across the two dimensional overlay present a peak at the point where the shift aligns the two arrays producing the highest possible match. It is not known a priori what that optimal shift alignment could be, so the arrays are overlapped in the two dimensions in order to find the peak. Equation (3) provides a description of what occurs at the peak of the correlation process. In this equation, F and T are considered to be random vectors with zero mean for simplicity. The expectation over the random vectors is considered to describe the auto correlation of T, and the cross correlation between F and T.

$$PeakCorrOutput ( F , T ) = \frac{E ( TT )}{{σ}_{F} {σ}_{T}} - \frac{E ( FT )}{{σ}_{T}^{2}} \qquad ( 3 )$$

If it is assumed that the standard deviations of F and T are roughly the same, the following results:

$$\begin{matrix}PeakCorrOutput ( F , T ) = \frac{E ( {T}^{2} )}{{σ}_{T}^{2}} - \frac{E ( FT )}{{σ}_{T}^{2}} \\ = 1 - \frac{E ( FT )}{{σ}_{T}^{2}}\end{matrix} \qquad ( 4 )$$

As it can be observed in Equation (4), the lowest possible value for the peak is zero, corresponding to a perfect match between F and T (i.e. F=T). The comparison procedure described above is repeated by the executing cross correlation software for each one of the reference patterns or templates and the peak value is recorded for each case. The highest peak value is taken among all the comparisons and compared against a pre-defined decision threshold as a matching criteria. If the lowest peak value is above the threshold then there is a match; otherwise there is not a match.

The system-level probability of compromise of a wrist-worn authentication device requires that the device be removed from the authenticated wearer without detection and that the imposter's wrist matches that of the authenticated individual. Alternatively, the imposter must obtain the authentication device (e.g. while it is not worn) and must perform a more stringent initial registration and authentication process.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A wrist contact sensor device for capturing a wrist vein pattern comprising:
at least one illuminator positioned in the device for contacting skin of a user on a palmar side of the wrist and directing infrared illumination into the palmar wrist skin;
the at least one illuminator being controlled by illumination drive circuitry under control of one or more communicatively coupled processors;
a plurality of sensors positioned in the device for contacting the skin of the user on the palmar side of the wrist, the plurality of infrared sensors detecting reflections and generating detection signals based on the detected reflections;
sensor interface circuitry supported by the support structure and interfacing with the plurality of sensors for receiving the detection signals and generating digital data representing a wrist vein pattern for the user based on the detection signals; and
the sensor interface circuitry sending the digital data representing the wrist vein pattern to the one or more communicatively coupled processors.

2. The system of claim 1 wherein the illumination and the reflections are near-infrared illumination and near-infrared reflections.

3. The system of claim 1 further comprising:
the plurality of sensors being in an array having more sensors along a horizontal direction across the wrist than along a vertical direction extending between a hand of the user and a forearm of the user.

4. The system of claim 3 wherein the array has an arrangement of 32×10 sensors in an area of 32 mm×19 mm.

5. The system of claim 3 wherein the array has an arrangement of 16×7 sensors in an area of 32×20 mm.

6. The system of claim 1 wherein the wrist contact sensor device is positioned on the wrist by a support structure which is wearable on the wrist.

7. The system of claim 6 further comprising a support structure for supporting the wrist contact sensor device in contact with the palmar side of the wrist of the user.

8. The system of claim 1 wherein the at least one illuminator comprises a single light emitting diode (LED) and a light diffuser.

9. The system of claim 1 wherein the sensor interface circuitry comprises circuitry for separating pulsatile components from non-pulsatile components in the detection signals being received from the sensors.

10. The system of claim 9 wherein the circuitry for separating pulsatile components from non-pulsatile components comprises a highpass filter for passing high frequency signals representing heartbeat data.

11. A method of authenticating a user based on data representing a wrist vein pattern comprising:
illuminating skin on a palmar side of a wrist with infrared (IR) illumination from one or more (IR) illuminators of a wrist contact sensor device;
generating detection signals representing infrared reflections detected by one or more (IR) sensitive sensors of the wrist contact sensor device, the sensors being in contact with the skin of the palmar side of the wrist;
generating digital data representing a wrist vein pattern based on the detection signals; and
sending the digital data to a communicatively coupled computer system having access to reference wrist vein pattern data.

12. The method of claim 11 further comprising:
separating pulsatile components from non-pulsatile components in detection signals from the sensors;
generating digital data representing a heartbeat pulse based on the pulsatile components; and
wherein sending the digital data over the communication network to a computer system having access to reference wrist vein pattern data includes sending the digital data representing the heartbeat pulse.

13. The method of claim 11 further comprising:
sending an identifier token identifying the wrist contact sensor device to the communicatively coupled computer system.

14. A method of authenticating a user based on data representing a wrist vein pattern comprising:
receiving by one or more computer systems the digital data representing the wrist vein pattern from a wrist contact sensing system;
automatically comparing the digital data representing the wrist vein pattern with digital data representing one or more reference wrist vein patterns using one or more pattern recognition techniques for identifying a matching reference wrist vein pattern satisfying a matching criteria;
responsive to finding a matching reference wrist vein pattern, automatically assigning an identity stored for the matching reference wrist vein pattern to a user associated with the received digital data representing the wrist vein pattern; and
notifying one or more executing applications requesting user authentication of the assigned identity of the user.

15. The method of claim 14 further comprising:
authenticating a wrist contact sensor device based on a identifier token received from the wrist contact sensing system.

16. The method of claim 14 further comprising:
identifying a health state of the user of the wrist contact sensor device based on received digital data representing a heartbeat pulse detected by an array of sensors of the wrist contact sensor device; and
notifying one or more executing applications requesting the health state of the identified health state of the user.

17. The method of claim 14 further comprising the one or more reference wrist vein patterns include digital datasets of wrist vein patterns generated for a same user at respective reference positions representing translation and rotation changes of the wrist contact sensor device from at least one of the reference positions.
